(19) United States
(12) Patent Application Publication
(10) Pub. No.: US 2015/0130178 A1
(43) Pub. Date: May 14, 2015

(54) Two-Way Read-and-Show Illustrated Flip-Over Storytelling or Picture Books and Aids

(71) Applicant: Jehan Clements, Peakskill, NY (US)

(72) Inventor: Jehan Clements, Peakskill, NY (US)

(21) Appl. No.: 14/080,236

(22) Filed: Nov. 14, 2013

(51) Int. Cl. B42D 1/00; B42C 19/00

(52) U.S. Cl. CPC B42D 1/009; B42C 19/00
USPC 281/38; 283/67; 412/6

(57) ABSTRACT

A book format, and methods to create such books, where the first story page on one of the leaves of the book and a second story page on an adjacent leaf are in diametric contraposition to each other. The first set of first story pages carries an illustration of a portion of a story with each successive first story page carrying another illustration of another portion of the story, so that the set of first story pages taken together illustrate substantially the entire story. The second story pages carry mirror images of the illustrations on their corresponding first story pages. The pages are disposed so that the audience sees the first story pages and their respective illustrations while the storyteller or reader sees the second story pages, optionally with text, and the mirror images of the illustrations corresponding to the first story pages viewed by the audience.

### BACKGROUND OF THE INVENTION

This invention relates to illustrated books or aids, methods to create such illustrated books or aids, and publishing systems, including software programs and/or kits, to create such illustrated books or aids; and more particularly, to improvement of two-way read-and-show illustrated flip-over storytelling or picture books or aids utilized by a person or persons to tell or relate a story to an audience of one or more persons, methods to create such two-way read-and-show illustrated flip-over storytelling or picture books or aids, and systems, including software programs and/or kits, to create two-way read-and-show illustrated flip-over storytelling or picture books or aids.

Storytelling and reading facilitate teaching a child to recognize letters, words, objects, persons, places, colors, things and the like, and help the child learn to read themselves. Moreover, storytelling and reading help to develop the child's imagination. Thus books and other things may often combine graphic illustrations, in color in many instances, and related words to provide a more interesting experience for the young child.

Several types of illustrative text have been arranged in book-format. For example, test-type book formats utilizing flash card type arrangements are described in U.S. Pat. No. 4,950,167, entitled “Visual Detail Perception Test Kit and Methods of Use” (describing cards or large pages mounted in a loose-leaf type binder so that one viewer, in this case a tester, can utilize the indicia on one page an odd page while the other viewer, the testee, can utilize the indicia on the corresponding proceeding, opposite, or facing page an even page). Such book forms, however, are only used as a test kit, and do not show, teach or even suggest a story that is to be read by one party to another. Similarly, the Woodcock-Johnson Psycho-Educational Battery by Teaching Resources Corporation utilizes a bound book-type holder for successive cards or pages so as to present a first page with a graphic and a related but incomplete sentence to a test taker and a second page with a substantially identical graphic and the same incomplete sentence to a tester and with teaching aids on the touters page. This test kit is also a compilation of separate and distinct two-page sets—each presenting a test but not cooperating with each other to do any more than present separate and distinct test sets.

In addition, Illustrated books or aids, methods to create such illustrated books or aids, and publishing systems, including software programs and/or kits, to produce such illustrated books or aids have been described. See, e.g., U.S. Pat. No. 5,713,743, entitled “Storytelling Flip Over Picture Book and Method of Providing and Presenting A Story,” U.S. Pat. No. 6,210,172, entitled “Do-It-Yourself Book;” U.S. Patent Publication No. 2005/020386, entitled “Flip-Over Storytelling Book Publishing System, Method, and Kit” While such patents and patent applications disclosed books or aids wherein the images or illustrations are on adjacent pages in the book in diametric contraposition, the images or illustrations on both adjacent pages are identical to each other. Therefore, while the person or persons that tells or relates the story to another person or group of persons can read the story while the audience also views the image, it is difficult for that person or persons to point to specific areas of the images or illustrations without stopping to look at the page the audience is viewing, thereby disrupting the flow of the storytelling.

Thus, there exists a need for improved two-way read-and-show illustrated flip-over storytelling or picture books or aids that can be utilized by a person or persons to tell or relate a story to another person or group of persons that are easier to simultaneous read and point for the audience's benefit at the same time, methods to create such two-way read-and-show illustrated flip-over storytelling or picture books or aids, and systems, including software programs and/or kits, to produce such two-way read-and-show illustrated flip-over storytelling or picture books or aids. The present invention addresses this need.

### SUMMARY OF THE INVENTION

The present invention is a two-way read-and-show illustrated flip-over storytelling or picture book or aid, wherein the book or aid is bound horizontally such that (1) at least one set of two adjacent pages (a) and (a*) on adjacent leaves in the book or aid are in diametric contraposition to each other wherein the binding is on the top edge of the two adjacent leaves with the set of two adjacent pages and (2) the images or illustrations (b) and (b*) in the two adjacent pages on adjacent leaves are mirror images of each other. The present invention is also directed to methods of storytelling or instruction using such two-way read-and-show illustrated flip-over storytelling or picture books or aids.

In addition, the present invention is directed to methods to create two-way read-and-show illustrated flip-over storytelling or picture books or aids, for example by a parent, teacher, or child. Yet another aspect of the invention is directed to publishing systems for creating such two-way read-and-show illustrated flip-over storytelling or picture books or aids. Such systems include a software program for generating from user input the adjacent pages (a) and (a*) either on or to be put on adjacent leaves that are in diametric contraposition to each other wherein the images or illustrations (b) and (b*) in the adjacent pages either on or to be put on adjacent leaves are mirror images of each other. Such systems optionally include a blank book that is composed, for example, of a front cover, a back cover, a binding, blank leaves, and/or pocket-leaves for insertion of the pages produced by using the software program.

Other objects, features and advantages of the invention in its details of construction and arrangement of parts will be seen from the above, from the following description of the preferred embodiment and from the appended claims.

### BRIEF DESCRIPTION OF THE FIGURES

FIG. 1 depicts one aspect of the invention wherein one set of two adjacent pages (a) and (a*) in the book or aid are in diametric contraposition to each other with the binding on the top edge of the two adjacent pages and the images or illustrations (b) and (b*) in the two adjacent pages are mirror images of each other. In this particular embodiment, the page to be viewed by the reader or instructor is the leaf containing page (a*), image or illustration (b*) and text (c*), while the page to be viewed by the audience of one or more persons is the leaf containing page (a), the mirror image or illustration (b), and text (c).

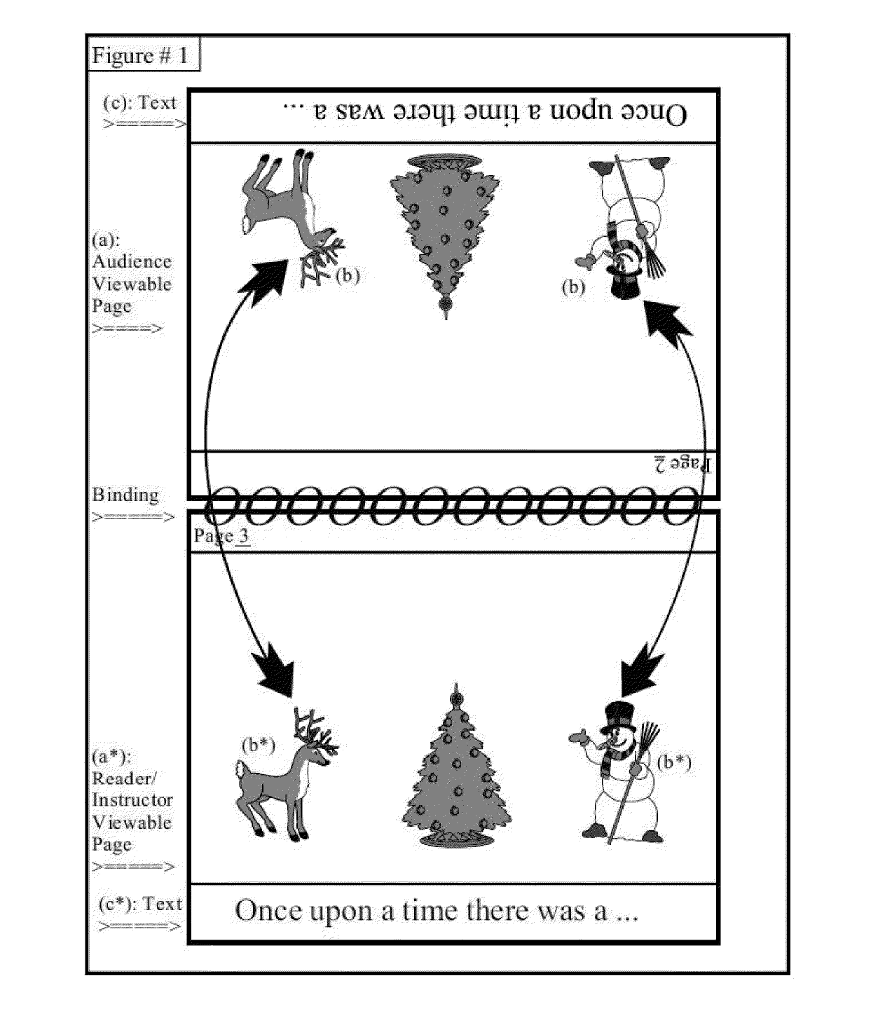

FIG. 2 depicts the problem with the two-way read-and-show storytelling or picture books of the prior art, e.g., in U.S. Pat. No. 5,713,743. When the reader or instructor tries to point to the images or illustrations (b) on the audience page (a), the images or illustrations (b*) that the reader or instructor sees on the right in their page (a*) are on the left-side of the audience page (a) facing away from them, and the images or illustrations (b*) that the reader or instructor sees on the left in their page (a*) are on the right-side of the audience page (a) facing away from them. Thus,the reader or instructor cannot easily point to objects on it e audience page (a) because the orientation of the images or illustrations (b*) are on opposite sides of each other.

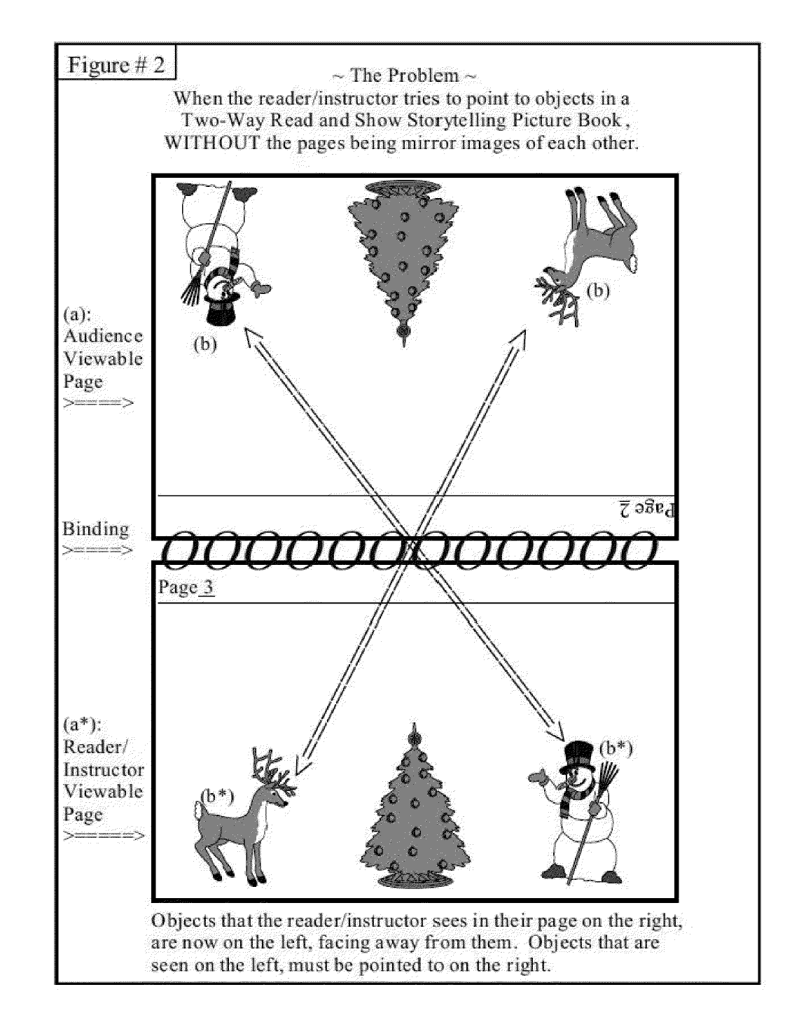

FIG. 3 depicts one aspect of the present invention that solves the problems in the prior art wherein the reader or instructor viewable page (a*) and adjacent audience viewable page (a) have images or illustrations (b) and (b*) that are mirror images of each other. Thus, the reader or instructor will be readily able to point to images or illustrations (b) facing the audience because the images or illustrations (b) are a mirror image of images or illustrations (b*) facing the reader or instructor.

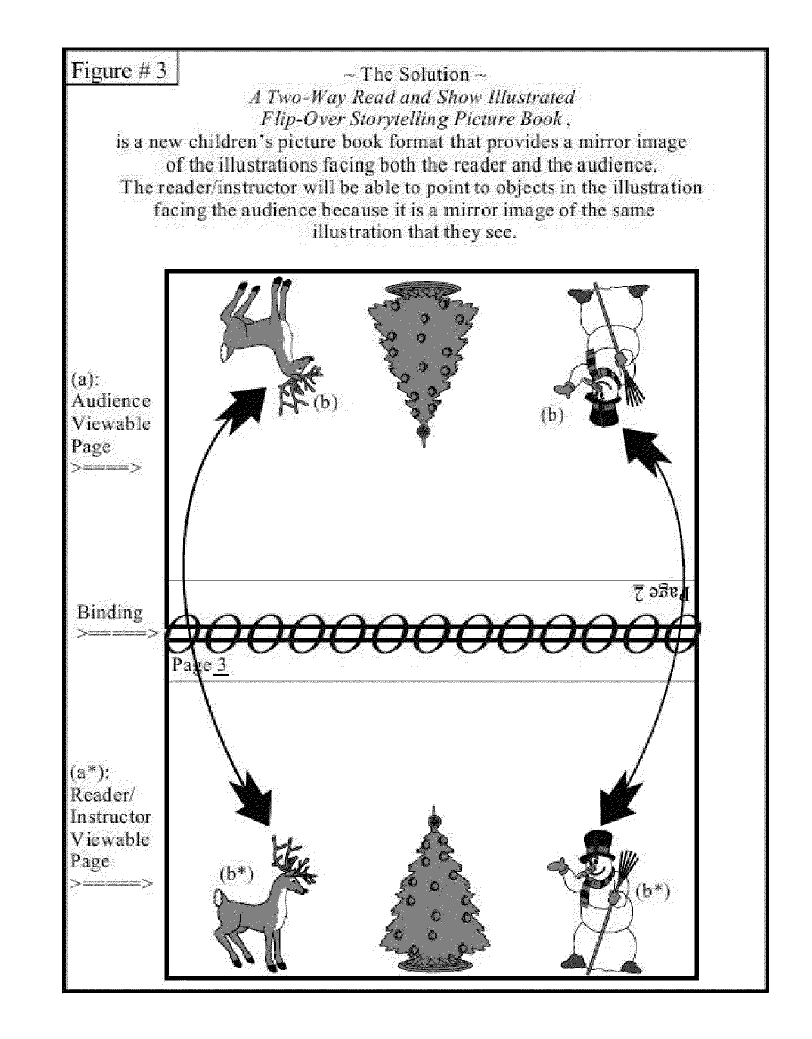

FIG. 4 depicts another aspect of the present invention, namely one set of adjacent pages of a two-way read-and-show illustrated flip-over storytelling or picture book or aid created and/or produced by a user optionally with the aid of a software program. The adjacent pages (a) and (a*) in the book or aid are in diametric contraposition to each other with the binding on the top edge of the two adjacent pages and the images or illustrations (b) and (b*) in the two adjacent pages are mirror images of each other. In this embodiment, the page to be viewed by the reader or instructor is the leaf containing page (a*), image or illustration (b*) and text (c*), while the page to be viewed by the audience of one or more persons is the leaf containing page (a) and the mirror image or illustration (b), but no text (c). In addition, in this embodiment, the adjacent pages (a) and (a*) in the book or aid include indicia, such as page numbers (d) and (d*) and binding instructions (e) and (e*).

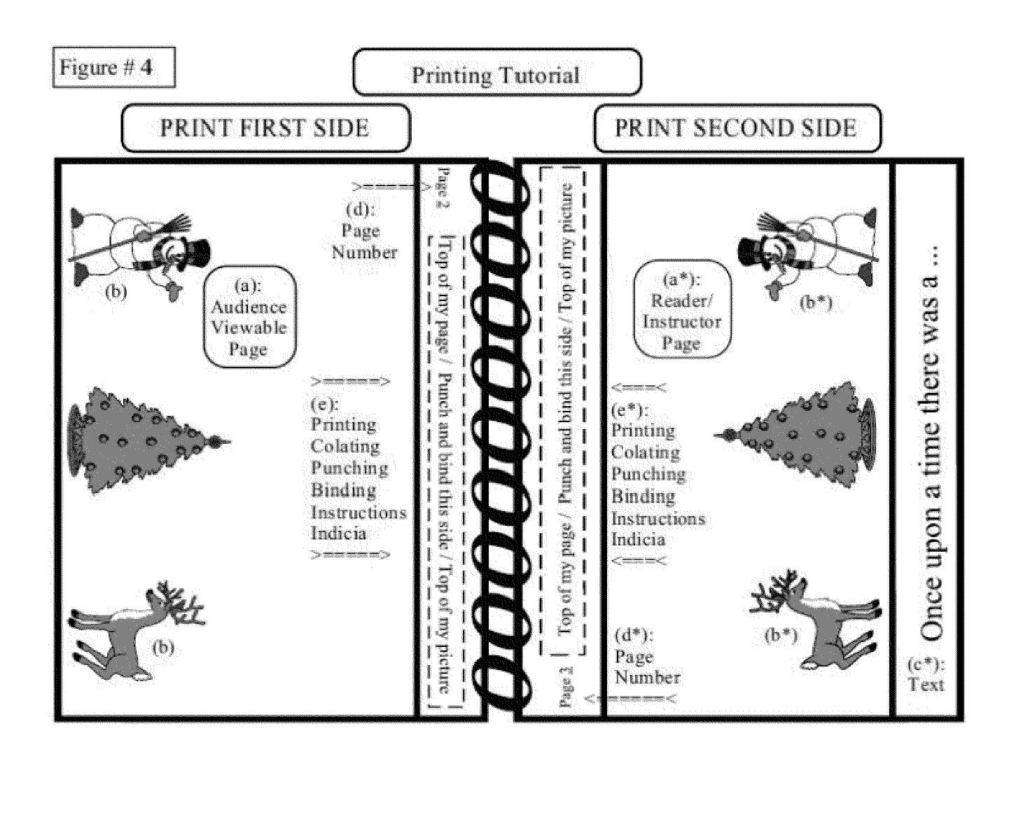

### DETAILED DESCRIPTION OF THE INVENTION

As used herein, the term “leaf” refers to a single sheet, of a material such as paper, having two sides. The term “page” refers to the subject matter printed, or to be printed, on one side of a leaf.

As used herein, the term “pocket-leaves” encompasses, but is not limited to, clear loose-leaf envelopes, clear loose-leaf page holders, clear plastic pocket pages or leaves, or other leaves having pockets, sleeves, slits, or envelopes, such as clear-plastic pocket envelopes, suitable for holding leaves containing printed pages, such as the story pages described above.

As used herein, the term “blank book” encompasses, but is not limited to, a book consisting only of a front and back cover and a binding, or to a book including these elements as well as essentially blank leaves of paper or pocket-leaves, as long as the blank book is suitable for the insertion of leaves containing printed pages on one or both sides. Accordingly, the printed pages on their leaves may be inserted into a blank book by, for example, printing pages onto leaves that are then bound, placing the leaves into a blank book in which the bound leaves are pocket-leaves suitable for receiving the printed pages, or affixing the printed pages to a blank book in which the bound leaves are essentially blank leaves suitable for affixing the printed pages.

As used herein, the term “picture” encompasses any type of graphics or illustration, or other forms of visual media, which is preferably but not necessarily without words or printed text.

As used herein, the term “diametric contraposition” refers to two adjacent leaves of paper that are bound such that the top of the images or illustrations printed on each of the leaves are diametrically contraposed to each other and bound together.

One embodiment of the present invention is a two-way read-and-show illustrated flip-over storytelling or picture book, wherein the book is bound horizontally such that (1) at least one set of two adjacent pages (a) and (a*) on adjacent leaves in the book are in diametric contraposition to each other wherein the binding is on the top edge of the two adjacent leaves with the set of two adjacent pages and (2) the images or illustrations (b) and (b*) in the two adjacent pages on adjacent leaves are mirror images of each other. When a reader is reading the book to an audience of one or more persons, page (a)—on the front side of the book—can be viewed by the audience while page (a*)—on the back side of the book—is being simultaneously viewed by the reader.

Another embodiment of the present invention is a two-way read-and-show illustrated flip-over storytelling or picture aid, wherein the aid is bound horizontally such that (1) at least one set of two adjacent pages (a) and (a*) on adjacent leaves in the aid are in diametric contraposition to each other wherein the binding is on the top edge of the two adjacent leaves with the set of two adjacent pages and (2) the images or illustrations (b) and (b*) in the two adjacent pages on adjacent leaves are mirror images of each other. When an instructor is using the aid to instruct an audience, page (a)—on the front side of the aid—can be viewed by the audience while page (a*)—on the back side of the aid—is being simultaneously viewed by the instructor.

In one preferred embodiment of the invention the adjacent pages (a) and (a*) on adjacent leaves have the images or illustrations (b) and (b*) respectively, and accompanying text (c) and (c*), respectively. In another preferred embodiment of the invention, only the page to be viewed by the reader or instructor, page (a*), has the image or illustration (b*) and text (c*), while the page to be viewed by the audience, page (a), has only the image or illustration (b). In another preferred embodiment of the invention, the adjacent pages (a) and (a*) have the images or illustrations (b) and (b*), but no text (c) or (c*).

In one embodiment of the invention, he images or illustrations (b) and (b*) are the same size. In another embodiment of the invention, the image or illustration (b) is larger than the image or illustration (b*).

In another aspect of the invention, the books or aids are children's books. In one aspect of the invention, the books or aids are pictorial books. In another aspect of the invention, the books or aids are fictional, such as fables or storybooks. In another aspect of the invention, the books or aids are nonfictional, such as textbooks, science books, history books, or social studies books.

In one embodiment of the invention, such books or aids are wire, spiral or loose-leaf bound. It should be understood, nevertheless, that other forms of reproduction of the graphics and text besides printing may be utilized, that the leaves of the book or aid may be bound together by wire, plastic, rings or other suitable and appropriate means that facilitate flipping of the leaves over the horizontal binding so that the book may be utilized such that the leaf containing page (a*) can be held relatively flat (i.e., about parallel with the floor) by the reader or instructor, for example, placed on the reader's or instructor's lap or on a flat or mostly flat surface, or slightly tilted toward the reader, for example, held in the reader's or instructor's hand, while the audience can simultaneously view page (a), i.e., the leaf containing page (a) is about perpendicular to the floor. Similarly, the book or aid may be bound together by wire, plastic, rings or other suitable and appropriate means that facilitate flipping of the leaves over the horizontal binding and that the book may be utilized in an easel-like configuration wherein page (a*) can be viewed by the reader or instructor while the page (a) can be simultaneously viewed by the audience.

In one aspect of the invention, he book or aid has a plurality of leaves containing even-numbered Pages 2, 4, 6, 8, 10, 12, etc., to be viewed by the audience of one or more persons, and odd-numbered Pages 3, 5, 7, 9, 11, 13, etc., to be viewed by the reader or instructor, conventionally bound together as by conventional plastic and/or metal loops carried by a spine and in a manner that facilitates the audience to view Pages 2, 4, 6, 8, 10, 12, etc., while the reader or instructor simultaneously reads Pages 3, 5, 7, 9, 11, 13, etc. A front cover and a back cover may be provided for the book or aid. The covers may be of the same stock as that of the leaves containing Pages 2-13, etc., or of different stock, and may be of the same size as the leaves containing Pages 2-13, etc., or slightly larger and/or made of a heavier and/or thicker material, as conventionally done for many books.

One preferred embodiment of the invention is directed to methods of storytelling or instruction comprising (1) holding at least the leaves containing pages (a*) of the present book or aid in one hand wherein the leaves containing pages (a*) in the book or aid are tilted toward the reader or instructor or are parallel to the floor such that the reader or instructor is viewing page (a*) while the audience is simultaneously viewing page and the other hand is optionally free to flip the leaves of the book or aid over the horizontal binding; (2) reading or instructing the audience based on what is on page (a*) while the audience is simultaneously viewing and/or reading page (a), and optionally (3) pointing or directing the audiences' attention to the image or illustration (b) and/or text (c) without looking at page (a).

Another preferred embodiment of the invention is directed to methods of storytelling or instruction comprising (1) placing at least the leaves containing pages (a*) of the present book or aid on the lap such that the reader or instructor is viewing page (a*) while the audience is simultaneously viewing page (a); (2) reading or instructing the audience based on what is on page (a*) while the audience is simultaneously viewing and/or reading page (a), and optionally (3) pointing or directing the audiences' attention to the image or illustration (b) and/or text (c) without looking at page (a).

Another preferred embodiment of the invention is directed to methods of storytelling or instruction comprising (1) placing at least the leaves containing pages (a*) of the present book or aid flat on a table or other flat or mostly flat surface such that the reader or instructor is viewing page (a*) while the audience is simultaneously viewing page (a); (2) reading or instructing the audience based on what is on page (a*) while the audience is simultaneously viewing and/or reading page (a), and optionally (3) pointing or directing the audiences' attention to the image or illustration (b) and/or text (c) without looking at page (a).

Another preferred embodiment of the invention is directed to methods of storytelling or instruction comprising (1) placing the book or aid in an easel-like configuration such that the reader or instructor is viewing page (a*) while the audience is simultaneously viewing page (a); (2) reading or instructing the audience based on what is on page (a*) while the audience is simultaneously viewing and/or reading page (a), and optionally (3) pointing or directing the audiences' attention to the image or illustration (b) and/or text (c) without looking at page (a).

Another embodiment of the present invention is a method to create such two-way read-and-show illustrated flip-over storytelling or picture books or aids, fir example by a parent, teacher, or child. Yet another aspect of the invention is directed to publishing systems for creating such two-way read-and-show illustrated flip-over storytelling or picture books or aids. Such systems include a software program for generating from user input the adjacent pages (a) and (a*) which can be placed onto adjacent leaves that are in diametric contraposition to each other wherein the images or illustrations (b) and (b*) in the adjacent pages are mirror images of each other. Such systems can optionally also include a blank book that is composed, for example, of a front cover, a back cover, a binding, blank leaves, and/or pocket-leaves for insertion of the pages produced by using the software are program.

The following non-limiting examples will illustrate in more detail the various aspects of present invention.

### EXAMPLE 1

A book or aid is horizontally bound, e.g., is spiral, wire-O, or comb bound, to (1) facilitate the easy flipping of the leaves of the book over the horizontal binding, (2) facilitate the ability to hold the leaves containing the odd-numbered pages in the reader or instructors hand, to place the leaves containing the odd-numbered pages on the reader's or instructor's lap or other flat or mostly flat surface, or to stand the book in an easel-like configuration, and (3) facilitate reading and telling of the story and use of the book.

The leaves of the book or aid containing Pages 2-13 etc., each include a first or front side facing Page 2, 4, 6, 8,10, 12, etc., (a), intended for viewing by the audience, and a second or back side facing Page 3, 5, 7, 9, 11, 13, etc., (a*), intended for viewing by the reader or instructor. Each even-numbered page includes an image or illustration (b) illustrating a portion of a story and each image or illustration (b) in an even page has a corresponding mirror image or illustration (b*) in the odd-numbered pages, which together and successively illustrate the story. In one example, the even-numbered pages do not have words or printed text (c). In another example, some or all of the even pages have words or printed text (c). In one example, the images or illustrations (b) in even pages are of a proportionally reduced size relative to the images or illustrations (b*) in the odd-numbered pages. For example, the image or illustration (b*) in Page 15 is a mirror image of the image or illustration (b) in Page 14, and (b) and (b*) are of the same size. In another example, the image or illustration (b*) in Page 17 is a mirror image of the image or illustration (b) Page 16, but the image or illustration (b*) in Page 17 is of a reduced size relative to the image or illustration (b) in Page 16.

The image or illustration (b) in the even-numbered pages (a) are preferably sized to encompass substantially the entire leaf and are preferably in color but may be in black and white, or otherwise. The image or illustration (b) in the even-numbered pages (a) depict a portion of the intended story and do so on successive leaves in the book or aid in the sequence of the story to be told or read aloud. The image or illustration (b*) in the odd-numbered pages (a*) are mirror images of their respective and corresponding image or illustration (b) in the even-numbered pages (a as described above, wherein the odd-numbered and even-numbered pages are in diametric contraposition to each other. In one example, the image or illustration (b*) in the odd-numbered pages (a*) is sized smaller than the corresponding image or illustration (b) in the corresponding even-numbered page (a). In another example, the odd-numbered pages (a*) also contains text (c*). In certain embodiments, the text (c*) may constitute a portion of the story corresponding to the corresponding image or illustration (b*), i.e., the text (c*) on Page 19 corresponds and relates to the images or illustrations (b) and (b*) in Pages 18 and 19, respectively. In one example of the invention, the text (c*) can be disposed above or below the image or illustration (b*) in the odd-numbered page. In certain other embodiments, the text (c*) may include questions for the audience pertinent to the story line to assist the reader or instructor or include other pertinent material or information for the reader or instructor that may or may not be shared with the audience. In addition, additional pages may be bound into the book or aid by the binding with other information, textual material, questions, hints, aids and the like included thereon.

In use, the reader or instructor can place the book or aid in an easel-like configuration with the even-numbered pages (a) containing the full-page image or illustration (b) facing the audience. As such, the odd-numbered pages (a*) containing the corresponding mirror image (b*) which is optionally of reduced size, will face the storyteller or reader as will optionally, the corresponding text (c*). The reader or instructor then starting at the beginning (say Page 2) will begin the story with Page 2—the image or illustration (b) in Page 2 will be facing the audience and the image or illustration (b*) in Page 3 will be facing the reader or instructor. The image or illustration (b) in Page 2 will be a mirror image of the image or illustration (b*) in Page 3 and the reader or instructor can start the story. After completing reading Page 3 (and easily pointing to the images or illustrations (b) in Page 2 without looking away from Page 3, and asking any questions, etc.), the reader or instructor can then proceed to flip the page over the horizontal binding, resulting in Page 4 facing the audience and Page 5 facing the reader. Again, the reader or instructor can read Page 5 and seamlessly point to an relevant image or illustration (b) in Page 4 without looking away from Page 5 based on the image or illustration (b*) in Page 5. In this way, the reader and the audience can each see the material on the page facing them in the proper orientation (i.e., the pages are in diametric contraposition to each other). And, because the images and illustrations (b) and (b*) are mirror images of each other, the reader or instructor does not need to look at the audience's page to properly locate and point to the images or illustrations (b) in the audience's page. The storyteller or reader thus continues until the story and related questions and other text material are finished.

Alternatively, the book or aid may be used as described above but with its pages held in one hand of the reader. Or, the book or aid may also be used placed on the lap of the reader or placed flat on a surface, with the odd-numbered pages (a*) facing up for the reader or instructor and the even-numbered pages (a) hanging down over the knees of the reader or over the flat surface and thus facing the audience.

From the above description it will thus be seen that there has been described a new and improved book or aid which permits the audience to observe the images or illustrations of each successive portion of a story while presenting to the reader or instructor the same or corresponding image or illustration in a way that facilitates the reader's or instructor's interactions with the audience and the page the audience is viewing.

### EXAMPLE 2

In an alternate example, the text (c) and the corresponding image or illustration (b) from a story are in close proximity on the same page, so that an audience may see the image or illustration (b) and also see text (c) that is identical to, or related to, what is being read aloud to them by a reader or instructor. In this example, Page 20 has an image or illustration (b) and text (c) facing the audience and Page 21 has an image or illustration (b*) and text (c*) facing the reader or instructor. The image or illustration (b) in Page 20 will be a mirror image of the image or illustration (b*) in Page 21. The text (c) in Page 20 will be identical or related to the text (c*) in Page 21. Any combination of images or illustrations and text on the page facing the audience is within tire scope of the present invention so long as the images or illustrations (b) and (b*) are minor images of each other. The text (c) in the page facing the audience may, but need not, be identical to the text (c*) facing the reader or instructor. Similarly, the image or illustration (b) in the page facing the audience may, but need not, be of larger size than the image or illustration (b*) in the page facing the reader or instructor.

### EXAMPLE 3

In another example, a person, preferably a child, creates his or her own story and relates that story to an audience. In one embodiment, the book or aid is a teacher's aid especially designed for use in a classroom by students, when they are producing a single copy of an original story. The book or aid of the present invention adapted for use with this educational technique facilitates the educational process of writing, illustrating, designing, and then reading aloud a story created by the student. In another embodiment, the book or aid is a project a child can complete at home with a parent or guardian.

The computer software program of the present invention provides users, such as students in a school, with a graphical presentation on the computer screen to assist such users in writing and illustrating a story of their own creation in the form of a two-way read-and-show illustrated flip-over storytelling or picture book or aid wherein the pages on adjacent leaves are in diametric contraposition to each other and the images or illustrations for the user and the audience or viewer adjacent pages on the adjacent leaves are mirror images of each other. The software program may also be used in a home schooling environment with a personal computer and printer.

To begin, the software program provides a book cover in landscape view for the user to work with. The book cover may be further designed and customized with the use of backgrounds and clip art, so that it relates to the title and subject of the story created by the user.

The software program optionally facilitates the design of the front cover, title and/or author page, and/or rights page. For example, the software program produces a page in landscape view with the name of the book, the title of the story, and the name of the user. The software program can optionally request “rights” information, including any copyright or patent information, any classification information, which can then be automatically added to the bottom of the front cover or the inside title page. Thus, for example, the title page, which optionally is the reverse side of the front cover, includes any title or authorship information as well as any copyright or patent information and any classification information. In addition, the software program can prompt the user for information to be put on the title page, including who created the book or aid, what the book or aid was created for, when the book or aid was created, and/or why the book or aid as made; and based on the users responses to these questions, the software program can produce a title page and/or “rights” page.

The user can create art work using clip art or other graphic programs, and can write text for the story. An unlimited number of blank story screens are provided by the software program until the story is completed by the user. It is possible for the user to return to the front cover page, or any of the subsequent pages, to make changes to the art work and the text as many times as necessary. After the story is completed, the software program presents a slide show of all the pages of the story in succession. The story will be presented on the screen so the user has a more complete view of the story, and evaluate whether further changes are needed. In one example, the software program automatically produces and displays, preferably on the top edge of all of the pages, information and instructions as to which side edge of the printed leaves are to be punched and bound to form a two-way read-and-show illustrated flip-over storytelling or picture book or aid. The software program automatically produces and displays on the screen an additional page, corresponding to each page created by the user, for display to an audience or viewer—the image or illustrations that the user created and the image or illustrations that are produced by the program are mirror images of each other (the text, however, will not be mirror images, but will be appropriately oriented for reading by the audience or viewer). As an example, Pages 2 and 3 of the user's story may be displayed on the screen at the same time to more fully demonstrate their diametric contraposition and mirror image relationship to each other.

When the final version of the story is completed, the software program may display a tutorial, such as a video presentation, to teach the user how to print out the pages of the story. Using a printer connected to the computer, the user is given instructions how to print both sets of pages corresponding to each side of the leaves of the book. The software program may provide further instructions to the user as to how to punch and bind the front cover, the reverse side of the front cover, as well as the inside leaves, and then bind the blank back cover together with a horizontal binding, such as a spiral binding. The software program automatically orients the pages of the book so that the pages that the audience would see, as ell as the pages that the user would read from in the completed book, are displayed in diametric contraposition to each other within the book.

The publisher software program provides the user with tools to create an entire two-way read-and-show illustrated flip-over storytelling or picture book or aid. The front cover and all of the inside pages are created page-by-page on the computer screen, without the use of paper, until the user is ready to print out the book. Assuming that the final book is page-numbered sequentially, the user thus creates all of the odd-numbered pages of the story, and the software program automatically produces the even-numbered pages of the story.

### EXAMPLE 4

In the example described below, the pages in the book or aid are numbered, preferably sequentially. When the user presents the story to an audience, the user reads from Pages 3, 5, 7, 9, etc. and the audience will see Pages 2, 4, 6, 8, etc., at the same time. Pages 2 and 3, 4 and 5, 6 and 7, 8 and 9, etc., will be oriented in diametric contraposition to each other within the book and the images and illustrations on Pages 2 and 3, 4 and 5, 6 and 7, 8 and 9, etc., will be mirror images of each other. In this example, the odd-numbered pages are created by the user, and the even-numbered pages are automatically produced by the software.

The software program optionally facilitates the design of the front cover, title and/or author page, and/or rights page. For example, the software program produces a cover page in landscape view with the name of the book, the title of the story, and the name of the user. On the screen there is a story screen page in the landscape mode with text boxes for the user to type in the author's name and the title of the story. The user may, for example, change the color of the background and/or paste or create art onto the cover page that relates to the title and subject of the story.

The software program can optionally request “rights” information, including any copyright or patent information, any classification information, which can then be automatically added to the bottom of the front cover or the inside title page. Thus, the “rights” information, including any copyright or patent information, any classification information, optionally can be included at the bottom of the reverse side of the front cover page. For example, the software program produces a title page and/or rights page, which is the reverse side of the front cover. This page will then be displayed on the screen in landscape mode and will show the name of the book, authorship information, and any “rights” information, including any copyright or patent information and any classification information. In addition, the software program can prompt the user for information to be put on the title page or rights page, including who created the book or aid, what the book or aid was created for, when the book or aid was created, and/or why the book or aid was made; and, based on the users responses to these questions, the software program can produce a title page and/or “rights” page. For example, the reverse side of the cover page is automatically produced by the book publisher software program when the user clicks on the “Finished” button located at the bottom of the front cover page screen.

The front cover of the book and the reverse side of the cover may be printed separately from the inside pages. For example, one piece of glossy photo paper is placed into the feeder tray of the printer. By clicking on the “Print” button, the printer prints the cover page on the glossy side. By simply flipping the page over and placing it back into the feeder tray in the same direction that it came out of the printer, and clicking on the “Print” button, the printer prints the back of the cover page on the matte finish side.

The binding edge of the cover and the binding edge of the reverse side of the cover are punched on the same top edge. The software program automatically orients the reverse side of the cover so that it appears right-side-up to the audience when the user reads the book aloud to an audience.

The software program automatically produces another title page for the book. This would be “Page 1” of the inside leaves of the book. This page contains the name of the hook, the title of the story, and the name of the user. The software program automatically produces the “Rights” information at the bottom of this page.

The software program optionally also produces indicia, such as page numbers and/or binding instructions, on Page 1 of the book.

A blank story screen for an odd-numbered page will appear when the user clicks on the “Finished” button on the screen at the bottom of the page. The user will begin the story by typing in the text box, or begin by pasting art into the picture box displayed within the story screen produced by the software program. The user clicks on the “Finished” button to move to the next page.

The text box provided by the software program contains, or operatively relies on, a word processing program. Using the “Text Format” buttons in the tool bar, the user will be able to format, for example, the font, style, size, color, and justification of the words of the story.

Clip art that the user may use to illustrate the story may be stored within the computer. For example, the clip art may be downloaded as part of the installation of the software program in the computer. The user may have access to different backgrounds to give an environment for the story. The user may paste clip art of objects, plants, animals, and people into the picture box within the story screen to illustrate a portion of the story. As an alternative, the software program may have drawing tool buttons for creating original artwork for the user's story.

By clicking on the “Finished” button, the software program allows the user to move onto the next odd-numbered page in the book. The software program then provides a blank story screen for the next odd-numbered page. The user will continue to create the story, by typing words into the text box and by adding art into the picture box of the story screen.

In one example, the software program automatically produces indicia, such as page numbers and binding instructions, on the story pages of the book, for example to help the user with a first book created by the software. In another example, the software program does not produce such indicia, for example after the user becomes familiar with the binding instructions with pages in diametric contraposition to each other.

The user continues to write words and create illustrations for the story on the odd-numbered pages, and the software program continues to provide blank story screens until the user is finished with the story. By using the “Edit My Story”, “Back”, and “Next” buttons, the user is able to navigate through the story, and return to the cover or any of the inside story pages to make as many changes as necessary.

When the user is completely finished with the story, the user may click on the “Publish My Story” or “Slide Show” buttons. The “Publish My Story” button causes all of the pages to appear on the screen at the same time in thumbnail images. The “Slide Show” button causes all of the pages to be displayed on the screen one after another. The user will be able to navigate through the pages by using the “Back” and “Next” buttons on the screen, The “Publish My Story” and “Slide Show” presentations may be played as many times as necessary. This step is designed to provide the user with an overview of the entire story, without interruption, so an extra evaluation may be made. These two features will allow any user to read the story aloud off of the screen, but not make any changes to the illustrations or words.

The “Edit My Story” button may require the use of a password created by the original author/illustrator user. By clicking on the “Edit My Story” button, the software program takes the user to the front cover of the book. The user may make changes to the front cover (these changes, if they apply, will automatically be made by the software program to the reverse side of the front cover, and the first inside page of the book) and to any of the relevant inside pages of the book.

The software program will then display a tutorial, such as a video, to teach the user how the pages of the story will appear in the book. For example, Pages 2 and 3 will appear on the screen at the same time. Page 3 (and all odd-numbered pages) will have been created by the user as part of the input steps described above. Page 2 (and all even-numbered pages) is automatically produced by the software program such that the images or illustrations are mirror images of the images or illustrations on Page 3 (and all the respective odd-numbered pages). In a “story reading” version, if Page 3 has text, the software can produce the same text from Page 3 onto Page 2. In a “storytelling” version, the software does not produce any or all of the text onto Page 2. In both versions, the even-numbered pages may include an enlarged or enhanced version of the text or the images or illustrations appearing on the odd-numbered pages.

In one example, the software program displays Pages 2 and 3 vertically on the screen in diametric contraposition to each other. The software program may have a feature to display the orientation of the user's storybook pages that will be in diametric contraposition to each other. A “Full View” button feature in a “View” drop down menu in a tool bar on the page screen could show Pages 2-3, 4-5, 6-7, 8-9, etc., on the screen at the same time vertically and in diametric contraposition to each other.

In one example, the software program will automatically produce and display orientation indicia, such as page number and binding instructions, on the pages. These indicia will instruct the user as to which side edge of each page and leaf is to be punched and bound together, in diametric contraposition to each other. The indicia included on each of the printed pages are intended to help the user to orient the printed page and leaf of the book into its proper order and in proper diametric contraposition to each other, for example to help the user with a first book created by the software. Accordingly, these indicia may include symbols or written instructions and applied to the printed pages, with the pages and leaves punched and bound between the front and back cover of a blank book, or for orienting the printed pages in relationship to corresponding indicia on blank or pocket-leaves that will hold the printed pages on the leaves in place between the front and back cover of a book. This method would allow a user to quickly assemble a book or aid in the diametric contraposition format.

As an alternative, some of the orientation indicia, such as the instructions for where to punch and bind the top edge of all the pages, will appear only on the top edge of Page 1, because, for example, all the other pages underneath may be in their correct position and orientation as they come out of the printer. This method may be used after the user becomes familiar with the concept of diametric contraposition. As yet another alternative, after the user has become familiar with the concept of diametric contraposition, the software program will allow the user to remove any or all of the orientation indicia, such as binding instructions, prior to printing. As yet another alternative, after the user has become familiar with the concept of diametric contraposition, the software program will not automatically produce and display any or all orientation indicia, such as binding instructions, on the pages.

When the user is ready to print the story, the user will click on the “Print My Book” button. Continuing the example numbering scheme described above, stories created with the software program will end with an odd-numbered page. The software program may automatically produce an additional even-numbered page (e.g., with “The End” printed on it), which wilt be oriented for display to the audience at the end of the reading of the story. This additional even numbered page with “The End” printed on it will give the user, the software program and the printer a point of reference during the process of printing the inside pages of the book.

In one embodiment of the invention, the pages, leaves, and/or book are produced in the landscape mode, i.e., the width of the page, leaf, and/or book is greater than the height of the page, leaf, and/or book. Alternatively, the pages, leaves, and/or book are produced in the portrait mode, i.e., the height of the page, leaf, and/or book is greater than the width of the page, leaf, and/or book.

Once printed, the pages for the reader and the audience will be bound together with a horizontal binding, such as a spiral binding. The cover and inside pages will be in diametric contraposition to each other within the book. The user is now ready to read the two-way read-and-show illustrated flip-over storytelling or picture book or aid aloud to an audience.

### EXAMPLE 5

The following steps are to be followed if the user is using a printer that prints a single page (i.e., a single side of a leaf) at one time. The software program will display a video to teach the user how to work with the paper and the printer, and how the pictures and words for the story will be printed on both sides of the leaves of paper.

When the user clicks on the “Print First Side” button, all of the even-numbered pages will be printed out, for example in reverse order. The user will then take all of the pages/leaves, and turn them over, and place the leaves back in the feeder tray in the same direction that they came out of the printer.

When the user clicks on the “Print Second Side” button, all of the odd-numbered pages will be printed out in the same order, for example in reverse order. Thus, Page 1 with an inside title page will be on the top of the pile and Page 20, with “The End,” will be on the bottom of the pile. The user will then put the cover on top of the pile of the inside pages/leaves that are in their correct order and correct orientation, and take them to the punching and binding machine. The book cover and the inside pages/leaves may be punched and then bound together with a pre-punched blank back cover. In one embodiment, the pre-punched blank back cover is provided with the kit.

Alternatively, the user's story may be printed on both sides of the leaves as part of a single operation of a printer. By making use of a printer that prints on both sides of the paper at the same time (e.g., by printing one side and then the other before the leaf comes out of the printer), the pages may be automatically printed in diametric contraposition format.

### EXAMPLE 6

Another example of the present invention is a kit that includes the software program described above and a blank book for inserting pages in diametric contraposition to each other may be provided as a kit. A user may produce pages using the software program described above and then insert them into a blank book supplied as part of the kit.

In such a book or aid, rather than permanent pages on leaves, a kit is provided with a book with leaves that can hold insertion pages created by the author or illustrator. These page holders can be of any design (e.g., substantially clear loose-leaf envelopes open at the edges perpendicular to loops or even a blank surface directly bound by loops to which the insertion pages can be affixed), so long as the original and corresponding insertion pages (created as described belt) are in diametric contraposition to each other. The clear loose-leaf page holders may contain a stiff opaque insert to maintain their shape and provide a background for the insertion pages, as described above.

It is understood that although there has been shown and described a preferred embodiment of the invention that various modifications may be made in the details thereof without departing from the spirit as comprehended by the following claims.

I claim:

1. A two-way read-and-show illustrated flip-over storytelling or picture book or aid, wherein the book or aid is bound horizontally with a binding such that
(1) at least one set of two adjacent pages (a) and (a*) on adjacent leaves in the book or aid are in diametric contraposition to each other wherein the binding is on a top edge of the two adjacent leaves containing the set of two adjacent pages (a) and (a*); and
(2) images or illustrations (b) and (b*) in the two adjacent pages (a) and (a*) on adjacent leaves are mirror images of each other.

2. The book or aid of claim 1, wherein at least one set of adjacent pages (a) and (a*) have images or illustrations (b) and (b*) and accompanying text (c) and (c*).

3. The book or aid of claim 1, wherein for at least one set of adjacent pages (a) and (a*), page (a*) has image or illustration (b*) and text (c*), while page (a) has image or illustration (b) but no text (c).

4. The book or aid of claim 1, wherein at least one set of adjacent pages (a) and (a*) have images or illustrations (b) and (b*), but no text (c) or (c*).

5. The book or aid of claim 1, wherein the images or illustrations (b) and (b*) are the same size.

6. The book or aid of claim 1, wherein for at least one set of adjacent pages (a) and (a*), the image or illustration (b) is larger than image or illustration (b*).

7. The book or aid of claim 1 is selected from the group consisting of children's books, pictorial books, fictional books, fables, storybooks, nonfictional books, textbooks, science books, history books, and social studies books.

8. A method of storytelling or instruction comprising:
(1) holding at least the leaves containing pages (a*) of the book or aid of claim 1 in one hand wherein the leaves containing pages (a*) in the book or aid are tilted toward the reader or instructor or are parallel to the floor such that the reader or instructor is viewing page (a*) while the audience is simultaneously viewing page (a) and the other hand is optionally free to flip the leaves of the book or aid over the horizontal binding;
(2) reading or instructing the audience based on what is on page (a*) while the audience is simultaneously viewing and/or reading page (a); and
(3) pointing or directing the audience's attention to image or illustration (b) and/or text (c) without looking at page (a).

9. A method of storytelling or instruction comprising:
(1) placing at least the leaves containing pages (a*) of the book or aid of claim 1 on one's lap such that the reader or instructor is viewing page (a*) while the audience is simultaneously viewing page (a);
(2) reading or instructing the audience based on what is on page (a*) while the audience is simultaneously viewing and/or reading page (a); and
(3) pointing or directing the audience's attention to image or illustration (b) and/or text (c) without looking at page (a).

10. A method of storytelling or instruction comprising:
(1) placing at least the leaves containing pages (a*) of the book or aid of claim 1 flat on a table or other flat or mostly flat surface such that the reader or instructor is viewing page (a*) while the audience is simultaneously viewing page (a);
(2) reading or instructing the audience based on what is on page (a*) while the audience is simultaneously viewing and/or reading page (a); and
(3) pointing or directing the audience's attention to image or illustration (b) and/or text (c) without looking at page (a).

11. A method of storytelling or instruction comprising:
(1) placing at least the leaves containing pages (a*) of the book or aid of claim 1 in an easel-like configuration such that the reader or instructor is viewing page (a*) while the audience is simultaneously viewing page (a);
(2) reading or instructing the audience based on what is on page (a while the audience is simultaneously viewing and/or reading page (a); and
(3) pointing or directing the audience's attention to image or illustration (b) and/or text (c) without looking at page (a).

12. A method of creating the book or aid of claim 1 comprising
(1) using a book publishing system to produce from user input the adjacent pages (a) and (a*) with images or illustrations (b) and (b*) that are mirror images of each other;
(2) printing the adjacent pages (a) and (a*) on leaves of paper; and
(3) binding the leaves of paper such that the adjacent pages (a) and (a*) are in diametric contraposition to each other.

13. The method of claim 12, wherein the book publishing system automatically produces pages (a) with images or illustrations (b) to be mirror images of pages (a*) with images or illustrations (b*) created from user input.

14. The method of claim 12, wherein the book publishing system automatically produces pages (a*) with images or illustrations (b*) to be mirror images of pages (a) with images or illustrations (b) created from user input.

15. A kit for creating the book or aid of claim 1 comprising
(1) a book publishing system to produce from user input the adjacent pages (a) and (a*) with images or illustrations (b) and (b*) that are mirror images of each other; and
(2) a blank book that comprises a front cover, a back cover, a binding, blank leaves, and/or pocket-leaves for insertion of the pages produced by using the software program.

16. The kit of claim 15, wherein the book publishing system automatically produces pages (a) with images or illustrations (b) to be minor images of pages (a*) with images or illustrations (b*) created from user input.

17. The kit of claim 15, wherein the book publishing system automatically produces pages (a*) with images or illustrations (b*) to be mirror images of pages (a) with images or illustrations (b) created from user input.
